(19) United States
(12) Patent Application Publication
(10) Pub. No.: US 2020/0145338 A1
(43) Pub. Date: May 7, 2020

(54) APPLICATION SPECIFIC GATEWAY DEVICE

(71) Applicant: TERAFENCE LTD., Haifa (IL)

(72) Inventors: Shai Steven Dorot Ratzer, Netanya (IL); Naftaly Sharir, Zichron Yaakov (IL)

(73) Assignee: TERAFENCE LTD., Haifa (IL)

(21) Appl. No.: 16/179,948

(22) Filed: Nov. 4, 2018

(51) Int. Cl. H04L 12/859; H04L 12/851; H04L 12/26; H04L 29/08; H04L 12/66; H04L 29/06

(52) U.S. Cl. CPC H04L 47/2475; H04L 47/2483; H04L 43/026; H04L 67/2814; H04L 63/10; H04L 67/06; H04L 12/66; H04L 63/12; H04L 67/12

(57) ABSTRACT

An application specific gateway device includes a device data direction processor connectable to a particular type of internet of things (IoT) device and a client data direction processor connectable to a client of the IoT device. A data direction engine is connected between the device data direction processor and the client data direction processor. A communication state of the data direction engine is controllable by the device data direction processor to determine an enabled direction of data flow between the device data direction processor and the client data direction processor. The device data direction processor is configured to identify data that is received from the IoT device or from the data direction engine and that corresponds to a predetermined allowed data and communicate the received data, and to prevent communication of the received data if the received data does not correspond to the predetermined allowed data.

### FIELD OF THE INVENTION

The present invention relates to internet of things (IoT) and network of things (NoT). More particularly, the present invention relates to an application-specific gateway device for use with IoT or NoT.

### BACKGROUND OF THE INVENTION

The internet of things (IoT) or network of things (NoT) refers to devices that are configured to cooperate with other devices to which they are connected over a network. In many cases, the network may include the internet or a network that is otherwise accessible to a wide population. Thus, innumerable end devices that had previously been incorporated into closed systems are being opened to remote access and control via a network.

Various methods have been described for securing IoT devices from unauthorized access. Such methods include encryption in communication with the device, protection from unnecessary interactions, authentication codes, inspection of command packets, and secure booting.

### SUMMARY OF THE INVENTION

There is thus provided, in accordance with an embodiment of the present invention, an application specific gateway device including: a device data direction processor connectable to a particular type of internet of things (IoT) device; a client data direction processor connectable to a client of the IoT device; and a data direction engine connected between the device data direction processor and the client data direction processor, a communication state of the data direction engine controllable by the device data direction processor to determine an enabled direction of data flow between the device data direction processor and the client data direction processor, wherein at least the device data direction processor is configured to identify data that is received from the IoT device or from the data direction engine and that corresponds to a predetermined allowed data and communicate the received data to the data direction engine or to the IoT device respectively, and to prevent communication of the received data if the received data does not correspond to the predetermined allowed data.

Furthermore, in accordance with an embodiment of the present invention, the device data direction processor or the client data direction processor includes a complex instruction set computer (CISC) or a reduced instruction set computer (RISC).

Furthermore, in accordance with an embodiment of the present invention, the communication state is selected from a group of communication states consisting of: no data flow between the device data direction processor and the client data direction processor, half duplex or simplex data flow from the device data direction processor to the client data direction processor, half duplex or simplex data flow from the client data direction processor to the device data direction processor, and duplex data flow between the device data direction processor and the client data direction processor.

Furthermore, in accordance with an embodiment of the present invention, the data direction engine is controllable to limit communication to a data flow from the device data direction processor to the client data direction processor.

Furthermore, in accordance with an embodiment of the present invention, the data direction engine is further controllable to intermittently enable a data flow from the client data direction processor to the device data direction processor.

Furthermore, in accordance with an embodiment of the present invention, the IoT device is a file server, and wherein the data direction engine is controllable to enable communication of a list of files or a requested file from the device data direction processor to the client data direction processor, and wherein the data direction engine is controllable to intermittently enable communication from the client data direction processor to the device data direction processor.

Furthermore, in accordance with an embodiment of the present invention, the device data direction processor is configured to restrict the intermittently enabled communication to a file request.

Furthermore, in accordance with an embodiment of the present invention, the IoT device is a camera, and wherein the data direction engine is configured to enable communication of image data from the device data direction processor to the client data direction processor, and wherein the data direction engine is controllable to intermittently enable communication of a camera command from the client data direction processor to the device data direction processor.

Furthermore, in accordance with an embodiment of the present invention, the device data direction processor is configured to restrict the intermittently enabled communication to a previously determined camera command.

Furthermore, in accordance with an embodiment of the present invention, the application specific gateway device includes a data direction controller configured to control the communication state of the data direction engine.

Furthermore, in accordance with an embodiment of the present invention, the data direction controller is configured to enable remote control of the communication state.

Furthermore, in accordance with an embodiment of the present invention, the data direction controller includes a single board computer.

Furthermore, in accordance with an embodiment of the present invention, the device data direction processor is configured to be connected to a plurality of network of things (NoT) devices of a network of things.

Furthermore, in accordance with an embodiment of the present invention, the device data direction processor is configured to address each NoT device of the plurality of NoT devices individually.

Furthermore, in accordance with an embodiment of the present invention, a connection between the data direction engine and the device data direction processor or the client data direction processor is a connection of a group of connections consisting of an Ethernet line, a serial line, a parallel connection, or a wireless link.

Furthermore, in accordance with an embodiment of the present invention, the device is configured to emulate the IoT device to a client that is connected to the client data direction processor, and to emulate a client to an IoT device that is connected to the device data direction processor.

Furthermore, in accordance with an embodiment of the present invention, the device is plug-and-play connectable between the client and the IoT device.

There is further provided, in accordance with an embodiment of the present invention, a method for controlling operation of an application specific gateway device, the method including: receiving by device data direction processor of the device, the device data direction processor being connectable to a particular type of internet of things (IoT) device, data from the IoT device or from a data direction engine that is connected between the device data direction processor and a client data direction processor that is connectable to a client of the IoT device; identifying the received data; when the identified data corresponds to a predetermined allowed data, communicating the received data to the data direction engine or to the IoT device respectively; and when the identified data does not correspond to the predetermined allowed data, preventing communication of the received data.

Furthermore, in accordance with an embodiment of the present invention, the method further includes controlling a communication state of the data direction engine by the device data direction processor to determine an enabled direction of data flow between the device data direction processor and the client data direction processor.

Furthermore, in accordance with an embodiment of the present invention, controlling the communication state includes intermittently reversing the enabled direction of data flow.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1 schematically illustrates a system incorporating an application specific gateway device, in accordance with an embodiment of the present invention.

FIG. 2 schematically illustrates components of the application specific gateway device shown in FIG. 1.

FIG. 3 schematically illustrates an application specific gateway system for read-only access to a data file.

FIG. 4 schematically illustrates an application specific gateway device configured for connection to a network of things.

FIG. 5 schematically illustrates an internet of things in which communication with each IoT device is protected by an application specific gateway device.

FIG. 6 is a flowchart depicting an example of a method for application specific communication control.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, the conjunction “or” as used herein is to be understood as inclusive (any or all of the stated options).

Some embodiments of the invention may include an article such as a computer or processor readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein.

In accordance with an embodiment of the present invention, an application specific gateway device is configured to control communication between an internet of things (IoT) device and a client of the IoT device. As used herein, the terms “internet of things” and “IoT device” should be understood as referring also to a network of things (NoT) and NoT devices. A client refers to a device or system that is configured to communicate with the IoT device. For example, the client may receive data from the IoT device, e.g., in the case of a camera, sensor, or other device that is configured to send data. As another example, the client may send commands or data to the IoT device, e.g., in the case of a lamp, machine, alarm, or other device that perform an action in response to a command. A client may include a general purpose device, such as a computer, or a device with a specific function, such as a network video recorder (NVR) that is configured to communicate only with a camera.

At least functionally, the application specific gateway device may be considered as having two sides, a device side that may be connected to the IoT device, and a client side that may be connected to the client. The two sides are connected to one another by a control gate. Communications between the device side and the client side are controlled by the hardware and software components of the application specific gateway device. In particular, a direction of data flow between the device side and the client side may be controlled via a data direction engine of the control gate (typically restricted to a simplex mode). In some cases, the control gate may include a data direction controller that may modify operation of the data direction engine.

The application specific gateway device is configured to be connected between a particular type of IoT device and the client. In some cases, the application specific gateway device may be connected between a client and a network of IoT devices. The application specific gateway device is configured to emulate the client when communicating with the IoT device, and to emulate the IoT device (or network of IoT devices) when communicating with the client. Therefore, the application specific gateway device may be connected between the client and the IoT device without disruption to communication programming or protocols (e.g., may enable plug and play connection of the application specific gateway device).

The application specific gateway device is programmed, e.g., with firmware, that limits data transfer to a predetermined set of types of allowed data transfer. The types of allowed data may be specific to a particular IoT device, or to a particular application for which the IoT device is intended. Thus, data that is transmitted by a data source (IoT device or client) to the application specific gateway device that corresponds to an allowed data transfer may then be transmitted by the application specific gateway device to a data destination (e.g., client or IoT device, respectively). Any data transfer that is received from the data source by the application specific gateway device and that does not correspond to an allowed data transfer is not transmitted by the application specific gateway device to the data destination.

The types of allowed data transfers may be different for different types of IoT devices. In some cases, e.g., where no industry standard is in effect, the types of allowed data transfers may be different for similar IoT devices that are produced by different manufactures. Accordingly, firmware that indicates allowed data transfers may be uploaded to a data storage unit (e.g., memory or data storage device) of the application specific gateway device differ that is intended for use for a specific IoT device. For example, application specific gateway devices with preloaded firmware may be produced for common IoT devices. Application specific gateway devices with customized firmware may be produced for less widely used IoT devices.

The application specific gateway device may provide, maintain, and analyze communications over a secure data channel between the IoT device and the client.

In many cases, the IoT device that is connected to the application specific gateway device may be considered to be a secure device to which access may be relatively difficult. Thus, a side of the application specific gateway device that is connected to the IoT device may be considered to be a secured side. Therefore, the application specific gateway device may, at least in some cases, be configured to enable data flow from the IoT device to the client without restriction. Nevertheless, if the IoT device (e.g., a camera) were to be replaced with another device (e.g., a computer) that attempts to send data that does not correspond to allowed data, transmission of the data may be prevented by the application specific gateway device.

On the other hand, the client may be connected to the internet or one or more other networks that may be accessible to others. The client may be configured to access the IoT device via the network, and the application specific gateway device at the device. Thus, it is possible that a malicious party may access the network in an attempt to tamper with operation of the IoT device.

For example, a typical IoT device that is connected to the application specific gateway device may not be accessible for reconfiguring via any remote device other than via the application specific gateway device. It may be noted that an Internet Protocol (IP) address of the IoT device may not be available to any entity other than the application specific gateway device. An IP address (and logon password) may be available to other entities connected to a network and may thus address the IoT device via the application specific gateway device. Thus, if the application specific gateway device were to be disconnected from the IoT device, and if the IoT device were to be connected directly to the network, the device would not be accessible by any network entity. For example, in order for such an IoT device to be reconfigured or otherwise tampered with in any other way, the IoT device would have to be physically accessed. On the other hand, a command from an unauthorized client could affect operation of the IoT device. Therefore, the application specific gateway device may be configured to enable a command from a client to be transmitted to the IoT device only when the command corresponds to an allowed data transfer.

For example, in one example an IoT device may be a camera. In this example, the application specific gateway device may be connected to, e.g., by a wired or short range wireless connection, to the camera. In some cases, the application specific gateway device may be connected to a closed network of cameras (e.g., of a localized security system). The camera may be configured to transmit images to a camera client via the application specific gateway device. For example, the camera client may be a console that is accessible to security personnel and that includes a monitor or display for displaying the images. The camera client may be connected to the application specific gateway device, and thus to the camera, via a network that may be accessible to other parties, including malicious parties. Thus, the application specific gateway device may be configured to enable transmission of all of the image data from the camera to the camera client. An allowed command that is sent from the camera client to the camera may control a zoom of the camera. The application specific gateway device may be configured to enable a command to change a zoom of the camera to be sent from the camera client to the camera. On the other hand, any other type of command, e.g., to reboot the camera, or otherwise modify operation of the camera, may not be allowed by the application specific gateway device to be transmitted to the camera. Thus, the camera may be protected from unwanted or malicious tampering via a network.

In a case where it is possible to log into an IoT device, any associated login data may be stored exclusively in the application specific gateway device and may not be otherwise known. In order to log into the IoT device via the client, the client in effect interacts with the emulation of the IoT device of the application specific gateway device. The application specific gateway device in turn, may log into the IoT device using the stored login data. Therefore, an attempt to bypass the application specific gateway device, e.g., by physically disconnecting the IoT device from the application specific gateway device, may result in an inability to log into the IoT device.

An application specific gateway device may be implemented instead of other layers of security, or in addition to such security layers. The application specific gateway device provides a secure data channel and thus enables security at all layers of communication, including a physical layer, connectivity layers, and application layers. For example, the application specific gateway device may be configured to verify that it is connected to an expected device, the communication is in accordance with an expected communications protocol, and that the communicated data corresponds to an expected form of data, and to prevent communication from unauthorized devices, using unauthorized protocols, or consisting of unauthorized data. The application specific gateway device may thus provide a full security shield but may operate in the presence of any existing security layers between the client and the IoT device. For example, other layers of security may include secure booting, access control, device authentication, firewalling, intrusion protection systems, and security updates and patches.

Hardware components of the application specific gateway device may include one or more data direction engines, data direction processors, and data direction controllers. For example, a typical application specific gateway device may include a single data direction engine in the gateway, a data direction processor on the device side and another on the client sided, and, in some cases, a single data direction controller to control operation of the data direction engine. Software modules (e.g., stored as firmware or otherwise) may include a data exchange module, an engine control module, and a data gateway module. In some cases, software modules may also include a user interface, algorithms and analytics, and a remote control module.

The data direction engine is controllable to enable full control over a data path by enabling one of four communication states over the data path: blocked communication, communication in one direction only or in the opposite direction only, and two-way communication. For example, the communication state allowed by the data direction engine may be controlled by a general purpose input/output control of a data direction processor on a device side of the application specific gateway device.

The most common communication state typically is in a single direction or in the opposite direction (e.g., at different times). In many applications simultaneous two-way communication may not be necessary and may not be enabled. However, such alternating one-way communication may, in some cases, may emulate to the client and to the IoT device simultaneous two-way communication (e.g., software half duplex over hardware simplex communication).

Since, in typical operation, the IoT device is assumed to be secure and inaccessible to malicious tampering, the data direction engine may ordinarily enable data flow from the device side to the client side of the application specific gateway device. On the other hand, the data direction engine may only enable application-specific predetermined data flows from the client side to the device side.

In the example of an IoT device in the form of a camera, the data direction engine may be controlled to enable streaming of video or other image data from the camera that is connected to the device side of the application specific gateway device, to the camera client that is connected to the client side. During this time, data flow from the camera client to the camera may be disabled by the hardware of the data direction engine. However, in some cases, the data direction engine may be configured to enable data flow from the client side to the device at predetermined times. For example, logic that is programmed into the data direction processor of the device side of the application specific gateway device may be configured to enable from time-to-time a secure data flow, e.g., a request to change the zoom of the camera, from the client side to the device side. During data flow from the client side to the device side, the data direction processor on the device side of the application specific gateway device may control the content of the data flow such that only legitimate data flow is allowed. For example, any incoming data flow to the device side, e.g., a request to reboot the camera, may be transmitted by the device side to the IoT device as a command to change the zoom.

In some cases, the gateway may include a data direction controller. For example, the data direction controller may be controlled by physical contact with the application specific gateway device, e.g., by operating a switch on an exterior panel of the application specific gateway device, to change the state of the data direction engine, e.g., to block all communication. In some cases, the data direction controller may be operated from a remote location via a secure channel.

The application specific gateway device may be configured to prevent or inhibit one or types of attacks, e.g., by a malicious party who accesses a network to which the client is connected. For example, the application specific gateway device may ensure that an attempt at denial of service by blocking communication between the client and the IoT device does not damage the IoT device. The application specific gateway device may also block an attempt from the IoT device (e.g., if corrupted before installation or afterward) to generate a denial of service attack on the network (since such an attempt would not be identified as an allowed data transfer). The application specific gateway device may block an attempt to attack the IoT device by a command (e.g., to reboot of to change an identity or definition of the IoT device) that is not enabled by the software of the application specific gateway device. Logic that is programmed into the data direction processor on the device side of the application specific gateway device may prevent a malicious data transfer from an infected IoT device that is connected to the device side (e.g., was infected prior to connection or was physically tampered with after connection) to the client. Similarly, the data direction processor may prevent a malicious data transfer from the IoT device itself or from another IoT device that is connected to a network of IoT devices (e.g., such as a network of security cameras on a property).

An application specific gateway device as described herein may be advantageous over other security systems. A typical IoT device may be designed for low power consumption, may have limited connectivity, and may have only as much processing capacity and memory as needed to perform its intended tasks. Such a device typically does not have an operator that can input authentication credentials or decide whether an application should be rejected or trusted. The wide variety of IoT applications may pose a similarly wide variety of security challenges. An application specific gateway device as described herein may create a secure unidirectional (simplex) communications channel that is adaptable to many types of IoT devices, including highly sensitive IoT devices (e.g. security cameras, programmable loci controllers, medical implants, or other devices) and very low-cost IoT networks. (The communications channel itself may function to the client and IoT device as a typical bidirectional communications channel, the separation into unidirectional communications being internal to the application specific gateway device, e.g., software half duplex over hardware simplex.) A typical application specific gateway device may be compact, inexpensive (e.g., relative to other security systems), simple to install (e.g., by a user, rather than by a professional with specialized training), and may be compatible for use in parallel with other security layers. Such additional security layer may be applied, in particular, at the client side of the application specific gateway device which may be exposed to a publicly accessible network.

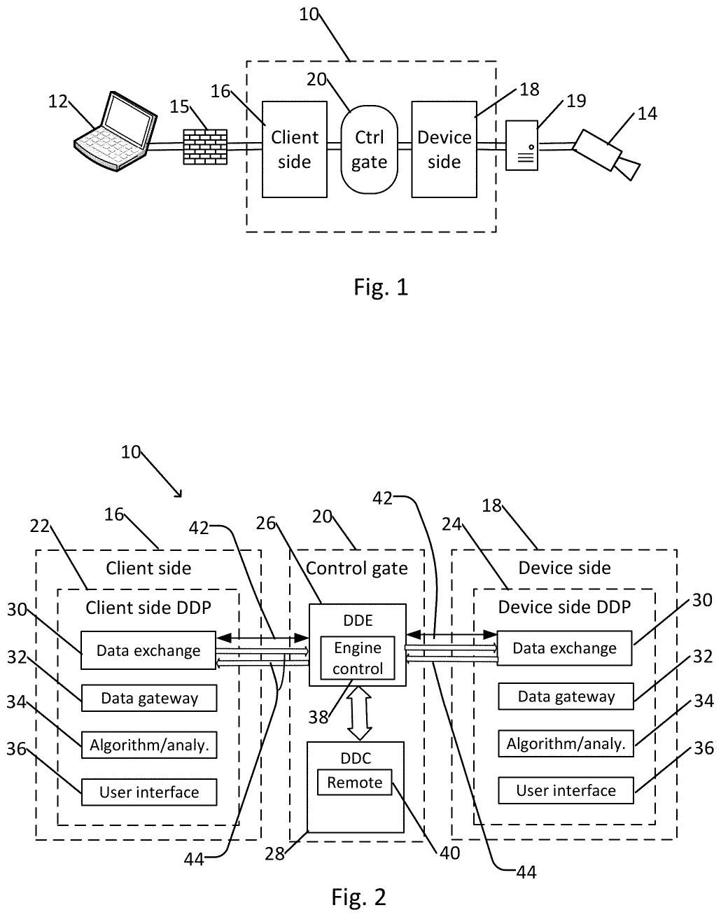

FIG. 1 schematically illustrates a system incorporating an application specific gateway device, in accordance with an embodiment of the present invention.

Application specific gateway device 10 is connected between client 12 and IoT device 14. Client 12 is connected to client side 16 of application specific gateway device 10, and IoT device 14 is connected to device side 18 of application specific gateway device 10. Communication between client side 16 and device side 18 is controlled by control gate 20 of application specific gateway device 10.

For example, client 12 may be connected to one or more networks. In some cases, client 12 may be configured to communicate with application specific gateway device 10 via the internet or another network or communications link (e.g., an Ethernet, WiFi, Long Term Evolution (LTE), cellular, or other wired or wireless network, or by a direct serial connection).

In some cases, one or more additional levels of security may be provided between client 12 and client side 16. For example, client 12 may be connected to client side 16 via a firewall 15, or another security system.

IoT device 14 may include a single device, or a network of interconnected devices. For example, IoT device 14 may include a single security camera or network of interconnected security cameras, a controller of a single elevator or a bank of coordinated elevators, a programmable logic controller (PLC), or another single device or network of intercommunicating devices or devices that communicate with a single network server 19 (e.g., including, or communicating with, a network switch or router). When IoT device 14 represents a network of devices, each IoT device 14 may be connected to device side 18 via network server 19.

Client side 16 of application specific gateway device 10 is configured (by programmed software or firmware) to emulate an IoT device 14. Thus, client 12 may communicate with client side 16 in a manner identical to communication directly with an IoT device 14. Similarly, device side 18 is configured to emulate a client 12. Thus, IoT device 14 may communicate with device side 18 in a manner identical with communication directly with a client 12 (e.g., substituting a communication address of device side 18 for the communication address of client 12).

FIG. 2 schematically illustrates components of the application specific gateway device shown in FIG. 1.

Client side 16 of application specific gateway device 10 includes a client data direction processor (DDP) 22. Similarly, device side 18 of application specific gateway device 10 includes a device data direction processor 24. For example, client data direction processor 22 or device data direction processor 24 may be based on a complex instruction set computer (CISC), a reduced instruction set computer (RISC), or on another type of computer, with or without an operating system.

Control gate 20 of application specific gateway device 10 is configured to control a direction of communication between client side 16 and device side 18. Control gate 20 may include a data direction engine (DDE) 26 that may be dynamically configured or controlled (e.g., by device side 18) to enable or disable communication between client side 16 and device side 18. For example, data direction engine 26 may include a processor that is configured to execute engine control software module 38 that determines a state of communications via data direction engine 26 (e.g., in accordance with instructions from device side 18). A state of communications may determine whether or not communications are enabled in either direction, or in both directions, across data direction engine 26.

Data direction engine 26 may be implemented by register-transfer logic (RTL), by control logic that is implemented using embedded controllers connected by an RTL communication link or by an optical communication control by RTL logic. Data direction engine 26 may be connectable by Ethernet lines, serial lines, parallel connection, or wireless links. In some cases, a connection between data direction engine 26 and device side 18 may be of one type (e.g., Ethernet or another type), while a connection to client side 16 may be of another type (the other side (e.g., wireless or another type).

Data direction engine 26 may be configured to force a half-duplex or simplex connection between client side 16 and device side 18. As used herein, a half-duplex connection refers to unidirectional communication at a single time over a communication channel, while a simplex connection refers to exclusive unidirectional communication over the channel. Thus, data direction engine 26 may be configured (e.g., by control signals from device side 18 or data direction controller 28) to restrict communication to a single direction, at least during a single time period, and may prevent direct access to device side 18 from client side 16, or vice versa.

In some cases, e.g., where the state of communications may be modified under at least some circumstances, control gate 20 may include a data direction controller (DDC) 28. For example, data direction controller 28 may include a single board computer, or another type of computer. Data direction controller 28 may be configured to control a state of communications across data direction engine 26.

In some cases, data direction controller 28 may include a remote control module 40. For example, data direction controller 28 may be configured to control a communications state of data direction engine 26 in accordance with instructions received via remote control module 40, or otherwise.

Thus, data direction controller 28 may allow for the option of remotely controlling (e.g., by a separate communications channel to remote control module 40, and not connected to client side 16) the physical connection between client side 16 and device side 18 by enabling a third party application to overrule any data flows 44 that were initiated by a data gateway module 32 (as described below) or any other attempts to initiate a data flow 44 by obtaining unauthorized access to client data direction processor 22 or device data direction processor 24, e.g., when the security of a connection to an external network is weak.

Each of client data direction processor 22 and device data direction processor 24 may be programmed with one or more data direction software modules that may be executed during operation of client data direction processor 22 or device data direction processor 24.

Data exchange module 30 may enable communication between client side 16 or device side 18 and data direction engine 26. For example, communication may include general purpose input/output control 42 and data flows 44. For example, general purpose input/output control 42 may enable device side 18 to control a state of communications via data direction engine 26.

Since bidirectional communication is vital to operation of many types of IoT device 14, data exchange module 30 may be configured to enable secure bidirectional communication (typically be enabling simplex communication in opposite directions during different time slots) between client data direction processor 22 and device data direction processor 24. Data exchange module 30 may provide security by defining a strict definition of allowed data flows 44 and controlling communication ports required to establish half-duplex communication.

For example, data exchange module 30 may establish an isolated command and control logic channel between client data direction processor 22 and device data direction processor 24 that may be used to pass system operation information between the data direction processor devices, as well as incoming requests which may be placed in a queue.

Data exchange module 30 may establish a simplex logic data channel, e.g., from device side 18 to client side 16. Such simplex communication may enable flow of data with minimum delay. When a transfer is attempted of data that does not originate from the allowed side, e.g., device side 18, data exchange module 30 may block the data flow while providing low level information regarding such an attempt, e.g., to an integration security layer.

Data exchange module 30 may be configured to receive or transmit application data from a port of client data direction processor 22 or device data direction processor 24 via a particular application that is running on data gateway module 32.

Data gateway module 32 may control communication between client 12 and client side 16, or between IoT device 14 and device side 18. For example, data gateway module 32 may apply one or more criteria to determine whether a particular data flow 44 conforms to one or more previously determined limitations on data flow.

Data gateway module 32 may be configurable (e.g., by software or firmware programming) to control access to client data direction processor 22 or device data direction processor 24, e.g., by client 12, or by IoT device 14. Data gateway module 32 may be configured to implement a strict definition of allowed data flows 44, e.g., based on a service that is required. When data gateway module 32 is configured with a strict definition, data gateway module 32 may protect a specific service from direct or side attacks regardless other types of security that are implemented. In some cases, access control tasks of data gateway module 32 need not be implemented when network access by client 12 is securely protected, e.g., by a virtual private network (VPN), by Hypertext Transfer Protocol Secure (HTTPS), or by other encryption. When all components and functions of application specific gateway device 10 are operational, the security provided by a Transmission Control Protocol (TCP) with strong username and password settings may be sufficient. A network that is connected to client side 16 cannot directly access a network that is connected to device side 18, or vice versa.

A security policy of data gateway module 32 may be implemented with minimum knowledge of other security components of application specific gateway device 10. Therefore, a user or customer of application specific gateway device 10 may implement one's own security strategy. A product integrator or original equipment manufacturer (OEM) vendor may be enabled to adapt data gateway module 32 to a product's needs without compromising the level of protection and functionality originally planned for the communication between the client and the IoT device.

In some cases, client data direction processor 22 or device data direction processor 24 may include and algorithm/analytics module 34. For example, algorithm/analytics module 34 may be configured to analyze a data flow 44 to profile data flow 44 and to determine whether a particular data flow 44 is to be allowed or restricted.

In some cases, client data direction processor 22 or device data direction processor 24 may include a user interface module 36. User interface module 36, may, for example, enable a user to communicate with client side 16 or with device side 18, e.g., to configure or otherwise communicate (e.g., for the purpose of maintenance or troubleshooting) with client side 16 or with device side 18.

In some cases, application specific gateway device 10 may be utilized in a system for read-only file access.

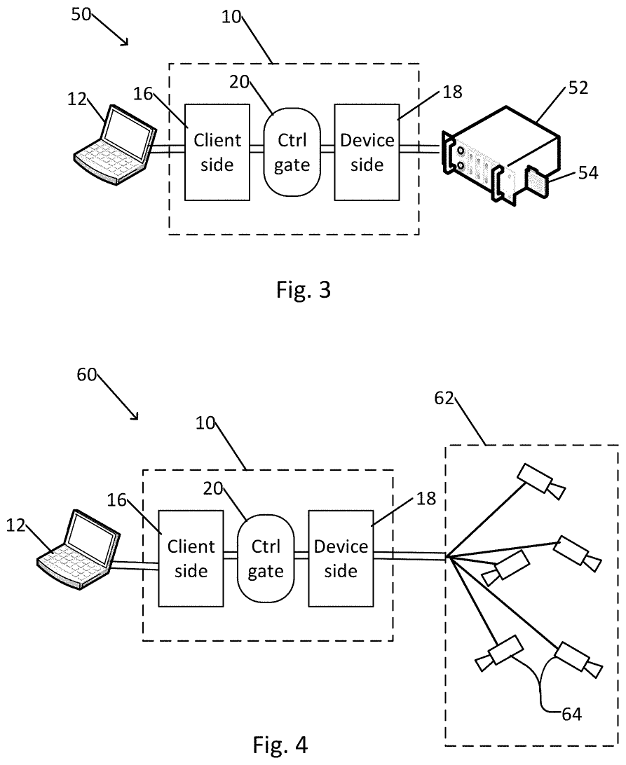

FIG. 3 schematically illustrates an application specific gateway system for read-only access to a data file.

In read-only file access system 50, file server 52 is connected to device side 18 of application specific gateway device 10.

A user with direct access to file server 52 may be enabled to perform all possible operations on file server 52. However, another, e.g., remote, user may access file server 52 only via application specific gateway device 10. In this case, application specific gateway device 10 may be configured to enable read access only to a file 54 that is accessible via file server 52. Thus, application specific gateway device 10 may prevent a user from deliberately or inadvertently modifying a file 54 that is accessible via file server 52.

In other cases, an application specific gateway device 10 may be configured to enable write-only access to file server 52.

For example, a client 12 who wishes to access file server 52 may access client side 16 of application specific gateway device 10. Device side 18 of application specific gateway device 10 may be configured to receive from file server 52 a file server tree that lists files 54 that are accessible by file server 52. Application specific gateway device 10 may be configured to enable the file server tree to be sent to client side 16. Thus, client 12 may access the file server tree via a connection to client side 16.

Client 12 may select for access a file that is listed in the file server tree and communicate the selection to client side 16 of application specific gateway device 10. For example, device side 18 (e.g., device data direction processor 24 of device side 18) may be configured to intermittently (e.g., periodically, or in response to one or more criteria, e.g., as determined by device data direction processor 24 of device side 18 for a particular application or IoT device 14) cause data direction engine 26 to enable data flow from client side 16 (e.g., for a minimum period of time, e.g., that is sufficient to enable data flow of a file selection and not longer) to receive a selection of a file from client side 16. If a file selection is received, the file selection may be communicated to file server 52.

File server 52 may then access and read the selected file 54 and enable a data flow (e.g., simplex flow in one direction) of contents of the selected file 54 to client side 16, where the file may be accessed by client 12.

Intermittently during the course of the data transfer of the contents of the selected file 54 from device side 18 to client side 16, a brief data flow from client side 16 to device side 18 may be enabled. During this brief data show, device side 18 may receive from client side 16 a list of errors or other indication of file transfer status). When the error list is empty or another indication is received that the transfer of the contents of file 54 has been completed, data flow from device side 18 to client side 16 may be stopped.

A similar system may be implemented to enable secure HTTP communication. For example, an application specific gateway device 10 may be inserted (e.g., as “plug and play”) into a connection between a web server/database server and a client 12 (and firewall 15). In this case, the web server/database server may be connected to device side 18 (similarly to file server 52). For example, the web server may manage a database to which periodically acquired images from a camera are stored.

A request from client 12 to view one of the stored images may be handled similarly to a request to obtain a file 54, as described above. Client 12 obtains an Internet Protocol (IP) address of client side 16 of application specific gateway device 10, rather than the IP address of the web server/database server or of the camera. Thus, the web server/database server and camera may be protected from an attack or tampering from client 12 or from a network to which client side 16 is connected.

As another example, an IoT device 14 may include an elevator controller that is connected to device side 18 of application specific gateway device 10. In this case, application specific gateway device 10 may be configured to enable client 12 to read a status of the elevator, while being prevented from controlling the elevator.

Typically, each IoT device 14 may be protected by an individual application specific gateway device 10 that is connected between that IoT device 14 and one or more clients 12. Each application specific gateway device 10 may be configured for a particular IoT device 14 to which that application specific gateway device 10 is connected.

In some cases, an application specific gateway device 10 may be configured to protect communication with a network of things (NoT), rather than with a single IoT device 14. In this case, a single application specific gateway device 10 may protect protected communication with an entire network of devices that is connected to one or more clients 12 via the single application specific gateway device 10.

For example, a network of things may include a network of cameras. A client of the network of cameras may be configured to communicate with each of the cameras, e.g., using an IP address and port number of each camera. Such a network may include a network of Real Time Streaming Protocol (RTSP) IP cameras and a client may include software on a terminal (e.g., as in a control center), a digital video recorder (DVR), a network video recorder (NVR), or another device.

FIG. 4 schematically illustrates an application specific gateway device configured for connection to a network of things.

In NoT system 60, device side 18 of application specific gateway device 10 is connected to network of things 62. Network of things 62 includes one or more NoT devices 64. In one example, NoT devices 64 may include cameras, sensors, or other security devices. In this example, client 12 may include one or more monitoring devices, such as display screens, recording devices, image analysis processors, or other devices of a management or security center. In other examples, NoT devices 64 and client 12 may include other types of devices.

Each NoT device 64 may be separately addressable by device side 18. For example, each NoT device 64 may be associated with a separate IP address. In the example, shown, each NoT device 64 is connected individually to device side 18. Software of device data direction processor 24 may enable device side 18 to communicate individually with each NoT device 64.

Alternatively, in a system that includes a network of things, individual NoT devices may be connect to a client via a separate application specific gateway device.

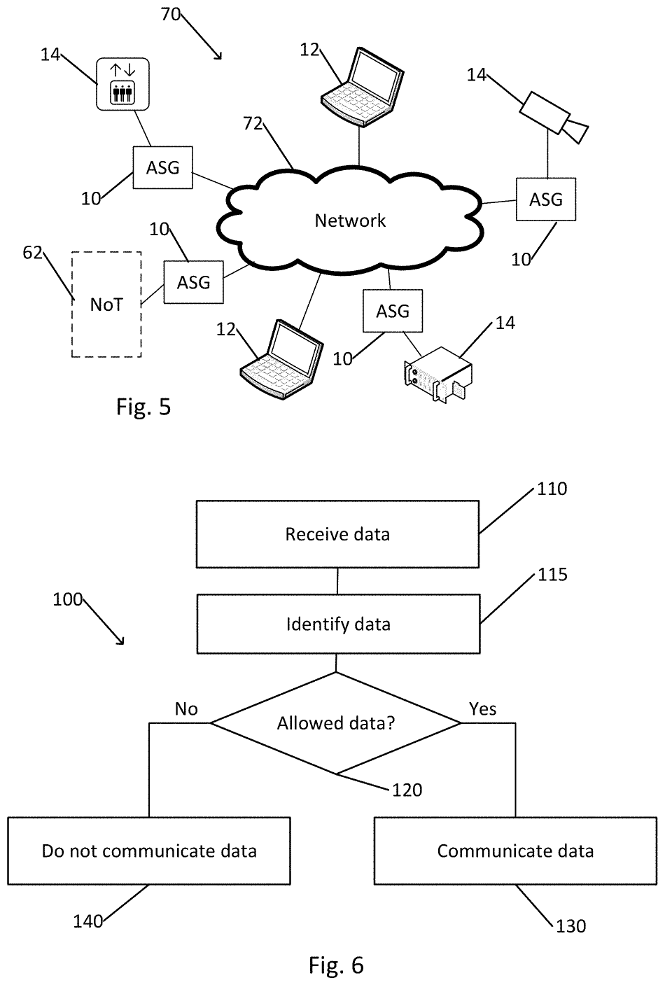

FIG. 5 schematically illustrates an internet of things in which communication with each IoT device is protected by an application specific gateway device.

In internet of things 70, one or more IoT devices 14, networks of things 62, and clients 12 are interconnected via network 72. Network 72 may represent the internet, a mobile phone network, or another wired or wireless network that may enable communication between two or more devices.

In internet of things 70, each IoT device 14 or network of things 62 is connected to network 72 via a separate application specific gateway device 10. Each application specific gateway device 10 may be configured in accordance with the type of IoT device 14 to which that application specific gateway device 10 is connected. For example, control of communication between an IoT device 14 and network 72 by application specific gateway device 10 may depend on whether IoT device 14 includes a camera, elevator, file server, or another type of device or network of devices.

One or more processors of application specific gateway device 10 may be configured to execute a method of application specific communication control. For example, device data direction processor 24 may be configured to control communication with an IoT device 14 or an NoT device 64.

FIG. 6 is a flowchart depicting an example of a method for application specific communication control.

It should be understood, with respect to any flowchart referenced herein, that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Application specific communication control method 100 may be executed by one or more processors of application specific gateway device 10. For example, application specific communication control method 100 may be executed by one or more of device data direction processor 24 and client data direction processor 22.

Application specific communication control method 100 may be executed when data is received by a processor that is executing application specific communication control method 100 (block 110). For example, the data may include a command for operating an IoT device 14 or NoT device 64 that is received by device data direction processor 24 via data direction engine 26. In some cases, the data may be received from an IoT device 14 or NoT device 64 for transmission to a client 12 via data direction engine 26.

In some cases, prior to receiving the data, device data direction processor 24 may control a communication state of data direction engine 26 to determine and enabled direction of communication between device data direction processor 24 and client data direction processor 22.

The received data may be identified by the processor that is executing application specific communication control method 100 (block 115).

The identified data may be compared with one or more predetermined allowed data flows (block 120). For example, in the case of an IoT device 14 or NoT device 64 in the form of a camera, an allowed data flow may include a command to change a zoom of the camera. In some cases, a particular data flow may be allowed for

If the received data is identified as corresponding to an allowed data flow, the data may be communicated to its destination (block 130). For example, device data direction processor 24 may communicate an allowed command that corresponds to the received data to a destination such as IoT device 14, NoT device 64, or data direction engine 26, depending on the type of date and the origin of the data.

If the received data is not identified as corresponding to an allowed data flow, the data is not communicated further (block 140). For example, no data may be transmitted to an intended destination, or the data that is transmitted may be modified to correspond to an allowed data transfer. For example, in the case that a computer is substituted for a camera, email data that is sent by the computer in accordance with an email protocol may be transmitted as image data using a video transmission protocol.

For example, in the case of an IoT device 14 in the form of a camera for which a client 12 may only be enabled to send a command to change a camera zoom. If another command (reboot the camera or another command) is received by device data direction processor 24, the command is not communicated to the camera. For example, no data may be communicated to the camera, or an allowed command to change the zoom may be communicated to the camera.

Different embodiments are disclosed herein. Features of certain embodiments may be combined with features of other embodiments; thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. An application specific gateway device comprising:
a device data direction processor connectable to a particular type of internet of things (IoT) device;
a client data direction processor connectable to a client of the IoT device; and
a data direction engine connected between the device data direction processor and the client data direction processor, a communication state of the data direction engine controllable by the device data direction processor to determine an enabled direction of data flow between the device data direction processor and the client data direction processor,
wherein at least the device data direction processor is configured to identify data that is received from the IoT device or from the data direction engine and that corresponds to a predetermined allowed data and communicate the received data to the data direction engine or to the IoT device respectively, and to prevent communication of the received data if the received data does not correspond to the predetermined allowed data.

2. The application specific gateway device of claim 1, wherein the device data direction processor or the client data direction processor comprises a complex instruction set computer (CISC) or a reduced instruction set computer (RISC).

3. The application specific gateway device of claim 1, wherein the communication state is selected from a group of communication states consisting of: no data flow between the device data direction processor and the client data direction processor, half duplex or simplex data flow from the device data direction processor to the client data direction processor, half duplex or simplex data flow from the client data direction processor to the device data direction processor, and duplex data flow between the device data direction processor and the client data direction processor.

4. The application specific gateway device of claim 1, wherein the data direction engine is controllable to limit communication to a data flow from the device data direction processor to the client data direction processor.

5. The application specific gateway device of claim 4, wherein the data direction engine is further controllable to intermittently enable a data flow from the client data direction processor to the device data direction processor.

6. The application specific gateway device of claim 4, wherein the IoT device is a file server, and wherein the data direction engine is controllable to enable communication of a list of files or a requested file from the device data direction processor to the client data direction processor, and wherein the data direction engine is controllable to intermittently enable communication from the client data direction processor to the device data direction processor.

7. The application specific gateway device of claim 6, wherein the device data direction processor is configured to restrict the intermittently enabled communication to a file request.

8. The application specific gateway device of claim 4, wherein the IoT device is a camera, and wherein the data direction engine is configured to enable communication of image data from the device data direction processor to the client data direction processor, and wherein the data direction engine is controllable to intermittently enable communication of a camera command from the client data direction processor to the device data direction processor.

9. The application specific gateway device of claim 8, wherein the device data direction processor is configured to restrict the intermittently enabled communication to a previously determined camera command.

10. The application specific gateway device of claim 1, further comprising a data direction controller configured to control the communication state of the data direction engine.

11. The application specific gateway device of claim 10, wherein the data direction controller is configured to enable remote control of the communication state.

12. The application specific gateway device of claim 10, wherein the data direction controller comprises a single board computer.

13. The application specific gateway device of claim 1, wherein the device data direction processor is configured to be connected to a plurality of network of things (NoT) devices of a network of things.

14. The application specific gateway device of clam 13, wherein the device data direction processor is configured to address each NoT device of the plurality of NoT devices individually.

15. The application specific gateway device of claim 1, wherein a connection between the data direction engine and the device data direction processor or the client data direction processor is a connection of a group of connections consisting of an Ethernet line, a serial line, a parallel connection, or a wireless link.

16. The application specific gateway device of claim 1, wherein the device is configured to emulate the IoT device to a client that is connected to the client data direction processor, and to emulate a client to an IoT device that is connected to the device data direction processor.

17. The application specific gateway device of claim 16, wherein the device is plug and play connectable between the client and the IoT device.

18. A method for controlling operation of an application specific gateway device, the method comprising:
receiving by device data direction processor of the device, the device data direction processor being connectable to a particular type of internet of things (IoT) device, data from the IoT device or from a data direction engine that is connected between the device data direction processor and a client data direction processor that is connectable to a client of the IoT device;
identifying the received data;
when the identified data corresponds to a predetermined allowed data, communicating the received data to the data direction engine or to the IoT device respectively; and
when the identified data does not correspond to the predetermined allowed data, preventing communication of the received data.

19. The method of claim 18, further comprising controlling a communication state of the data direction engine by the device data direction processor to determine an enabled direction of data flow between the device data direction processor and the client data direction processor.

20. The method of claim 19, wherein controlling the communication state comprises intermittently reversing the enabled direction of data flow.
